(19) United States
(12) Patent Application Publication
(10) Pub. No.: US 2008/0282502 A1
(43) Pub. Date: Nov. 20, 2008

(54) DEVICE FOR GUIDING CABLES BETWEEN A FRAME AND A WING

(75) Inventors: Markus Lenze, Nettetal (DE); Tibor Herglotz, Kreuzau (DE)

Correspondence Address: SUGHRUE MION, PLLC, 2100 PENNSYLVANIA AVENUE, N.W., SUITE 800, WASHINGTON, DC, 20037, US

(73) Assignee: Dr. Hahn GmbH & Co. KG, Moenchengladbach-Wickrath (DE)

(21) Appl. No.: 12/123,898

(22) Filed: May 20, 2008

Related U.S. Application Data
(63) Continuation of application No. PCT/EP2006/010055, filed on Oct. 19, 2006.

(30) Foreign Application Priority Data
Nov. 23, 2005 (DE) 20 2005 018 419.5

(51) Int. Cl. E05D 11/00

(52) U.S. Cl. 16/223

(57) ABSTRACT

A device for guiding cables between a fixed frame (1) and a wing (2), such as a door leaf or window casement, is pivotably mounted to the frame (1) via a hinge arrangement. The hinge arrangement has a hinge bracket mounted for pivoting about a frame hinge axis (R) that is located within the frame and about a wing hinge axis (F) that is located within the wing (2) and is parallel to the frame hinge wing (R). The device has a hollow element (5) that extends between the frame and the wing and is mounted for pivoting about the frame axis and the wing axis (R, F).

This is a Continuation of International Application PCT/EP2006/010055, with an international filing date of Oct. 19, 2006, which was published under PCT Article 21(2) in German, and the disclosure of which is incorporated into this application by reference. This application claims priority and benefit of German patent application 20 2005 018 419.5, filed Nov. 23, 2005. The disclosure of this application is also incorporated herein in its entirety.

### FIELD AND BACKGROUND OF THE INVENTION

The invention relates to a device for guiding cables between a fixed frame and a wing (e.g., a door leaf, window casement, a sash, or the like) pivotably mounted to the frame via a hinge arrangement. The hinge arrangement includes a hinge bracket mounted for pivoting about a frame hinge axis that is located within the frame and about a wing axis that is located within the wing and is parallel to the frame hinge axis.

Such a hinge arrangement is known from German Publication 101 05 264 C1, the complete disclosure of which is hereby incorporated by reference into the present application. Because of the hinge bracket, which is mounted in the frame at one end and in the leaf or casement at the other end, this hinge arrangement allows the leaf or casement to be opened at least almost by 180°. The pivoting about the leaf or casement hinge pin is spring-loaded by means of a return spring in a direction of rotation opposite the opening direction. As a result, when the leaf or casement is opened, pivoting initially occurs exclusively about the frame hinge pin until the maximum pivot angle of the bracket is reached, before continued opening of the leaf or casement causes the leaf or casement to pivot about the leaf or casement hinge pin, overcoming the force of the return spring.

This hinge arrangement is particularly suited for use in hollow profiles because it can easily be incorporated into the recesses that are necessary to accommodate the hinge arrangement completely within the interior so that it is not visible from the outside when the door leaf or window casement is closed. This invisibility in the closed state of the leaf or casement not only improves the appearance of the frame and leaf or casement arrangement but also completely prevents access to the hinge arrangement from the outside when the leaf or casement is closed. The security against burglaries achieved with door leaves or window casements mounted to frames in this manner is therefore particularly high.

The prior-art hinge arrangement known from German publication DE 101 05 264 C1 is therefore particularly suited for heavy outer door leaves, for example, external doors or external gates, in which devices are provided within the door leaves, such as electrical, hydraulic or pneumatic closing devices, alarms, lighting units, etc. To supply these devices with the necessary power, the power supply cables must be guided in such a way that they do not impede the pivoting movement of the leaf and there is no risk that the cables will be excessively stressed or become damaged by kinking or pinching when the door leaf is pivoted.

It is known to guide such cables, which are flexible in themselves, through a flexible hose that extends from the frame to the leaf. The hose is, for example, a corrugated hose and is designed to reliably prevent kinking or pinching. This type of cable guiding means has generally proven reliable and effective.

### OBJECT OF THE INVENTION

Although this cable guiding means has proven reliable in many cases, a disadvantage has been discovered, in that it is poorly suited or unsuited for leaves that pivot wide, because neither the flexibility of the hose nor that of the cables is sufficient to cover the distances caused by pivoting the leaf about the hinge pin.

It is therefore an object of the invention to provide a device for guiding cables between a fixed frame and a wing pivotably mounted to the frame, e.g., via the above-described hinge arrangement, in which the risk that the cables will be kinked or pinched between the wing and the frame is reduced, preferably even if the opening angle of the leaf or casement is 180°.

### SUMMARY OF THE INVENTION

According to one formulation of the invention, a hollow element is provided, which extends between the frame and the wing and is mounted for pivoting about the axis of the frame and the axis of the wing. Thus, the distance to be covered by the cable guiding means as a result of the pivoting movement of the wing no longer needs to be covered by an elastic deformation of the means. Rather, a rotation of the hollow element relative to the frame and the wing similar or identical to that of the hinge bracket about the wing axis and the frame axis addresses this need. The cables, which in practice are usually electrical cables, are guided through the hollow element. They are not or are only slightly deformed in the area between the frame and the wing as the wing is opened or closed, because they pivot about the frame axis and the wing axis together with the hollow element, which remains substantially undeformed. Since the cables are accommodated within the hollow element, they are moreover protected from being pinched between the wing and the frame.

To ensure that the hollow element is deformed as little as possible when the wing is opened and closed and furthermore does not hinder the opening and closing of the wing, it is particularly advantageous if the hollow element has approximately the shape of the hinge bracket as seen in the direction of the hinge axes. This ensures that the angular relationships in the hollow element are the same as those in the hinge bracket, so that the hollow element at least substantially follows the movement of the hinge bracket as the wing is opened and closed. This embodiment has the further advantage that the hollow element, which is visible when the wing is opened, looks at least similar to the hinge arrangement, so that the appearance of the frame-wing arrangement is improved when the wing is opened.

The hollow element is particularly cost effective to manufacture if it consists of an injection molded plastic part.

A particularly good and durable and at least predominantly invisible cable guidance is made possible if—which is preferred—hollow bolts are provided to mount the hollow element for pivoting about the frame axis and the wing axis and are received in the bolt seats provided on the frame and the wing. The cable is then guided from the end face of the bolt—typically from below—through the hollow element and out of the lower end face of the other hollow bolt. Thus, the cables are essentially subject to torsion in a pivoting movement of the wing. This torsional stress can be absorbed by many materials used for electrical, hydraulic or pneumatic cables. If this happens not to be true in a given situation because of special conditions, it is possible in addition to provide rotary transmission lead-throughs for hydraulic or pneumatic cables and sliding contacts for electrical cables at the ends of the hollow bolts.

These and other features of preferred embodiments of the invention are described in the claims as well as in the specification and the drawings. The individual features may be implemented either alone or in combination as embodiments of the invention, or may be implemented in other fields of application. Further, they may represent advantageous embodiments that are protectable in their own right, for which protection is claimed in the application as filed or for which protection will be claimed as permitted by law.

### BRIEF DESCRIPTION OF THE DRAWINGS

An exemplary embodiment of a device according to the invention is depicted in the drawing, in which:

FIG. 1 is a schematic perspective view of the narrow sides of a frame profile and a wing profile, with the wing opened by 180°, and the mounted embodiment of the device,

FIG. 2 is a top view of the same embodiment corresponding to FIG. 1, again with the wing opened by 180°,

FIG. 2a is a top view of a hinge arrangement located above or under the device according to the embodiment of the invention, again with the wing opened by 180°,

FIG. 3 shows the same embodiment in the same view as in FIG. 2 but with an opening angle of approximately 75°, and

FIG. 4 shows the same embodiment in the same view as in FIGS. 2 and 3 but with the wing closed.

### DETAILED DESCRIPTION OF THE PREFERRED EMBODIMENTS

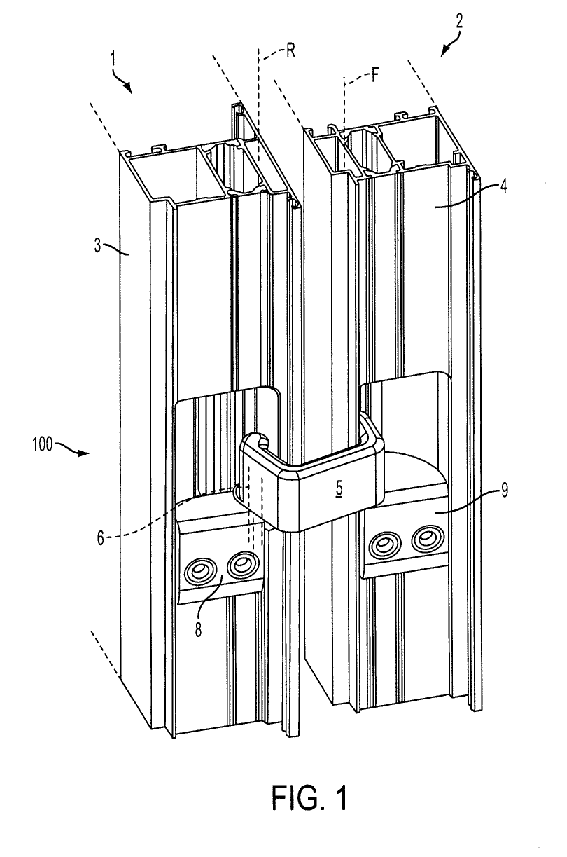

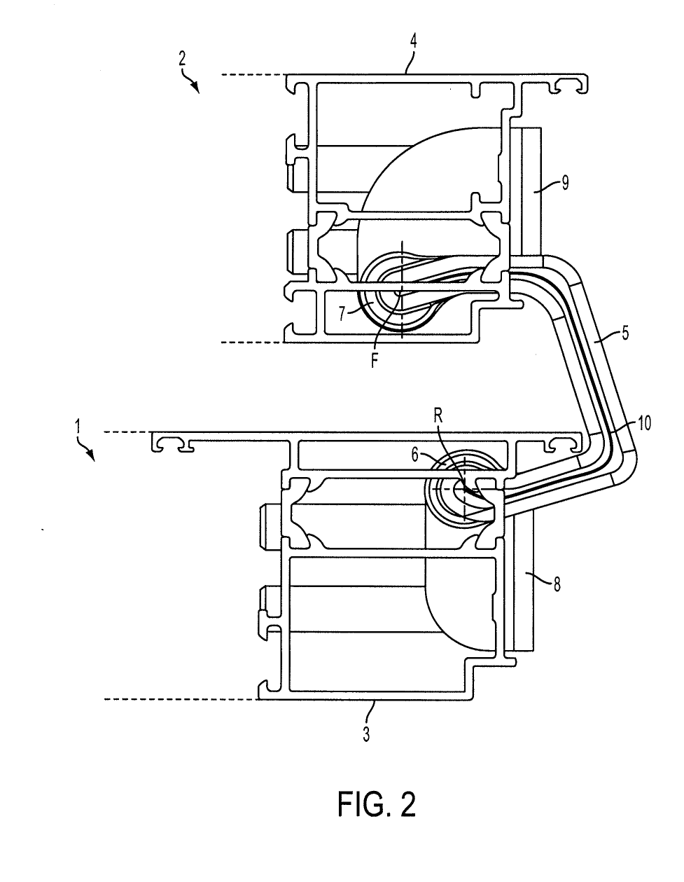

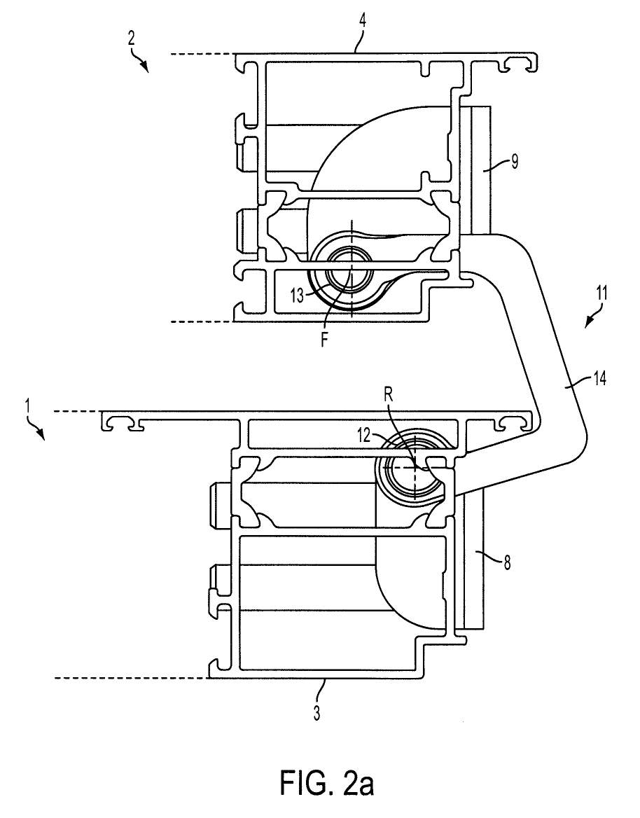

The device for guiding cables between a fixed frame 1 and a wing 2, e.g. a leaf or casement pivotably mounted to the frame via a hinge arrangement 11 (shown in FIG. 2a), such as the one disclosed in German publication DE 101 05 264 C1 (only the frame profile 3 of the frame 1 is shown and only the wing profile 4 of the wing 2 is shown). The device is identified in its entirety with reference numeral 100 in the drawing and includes a hollow element 5 extending between the frame 1 and the wing 2. With the hinge arrangement 11, which comprises a first hinge pin 12, a second hinge pin 13 and a hinge bracket 14, the frame is mounted for pivoting about a frame hinge axis R and the wing is mounted for pivoting about a wing hinge axis F. The hollow element 5 is also mounted for pivoting about the same hinge axes F, R, e.g. using hollow bolts 6, 7 (indicated only schematically in FIG. 1), which are mounted to the bolt seats 8, 9 provided on the frame profile 3 and on the wing profile 4.

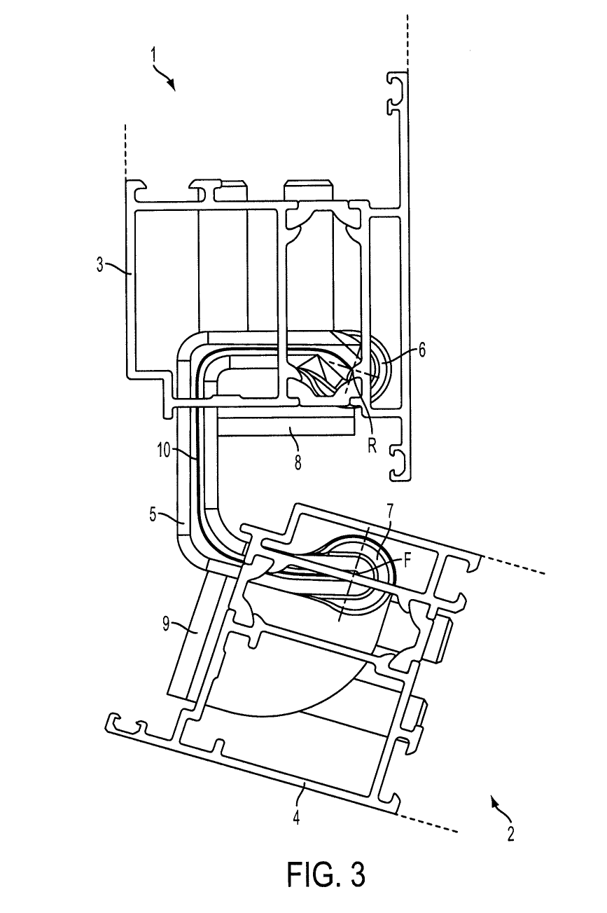

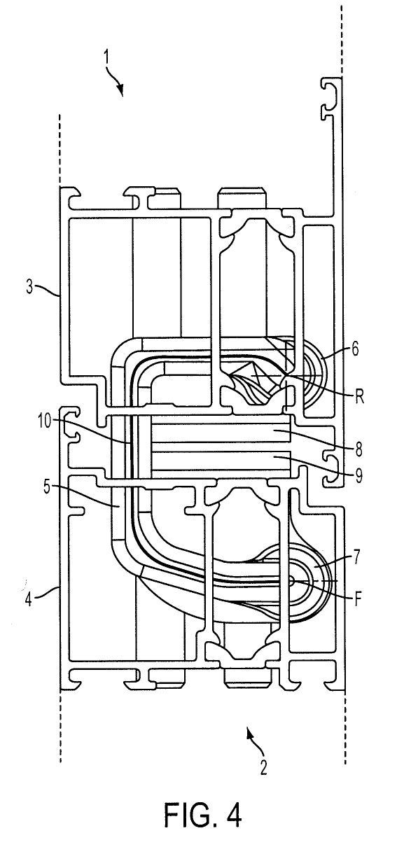

The hollow element 5 is used to guide a cable 10, which can be an electrical, hydraulic or pneumatic cable, for example. The term “cable” also includes cable aggregates, for example, an electric cable strand consisting of a plurality of individual wires. The cable 10 extends through the interior of the frame profile 3, through the hollow bolt 6 and the interior of the hollow element 5 via the hollow bolt 7 into the interior of the wing profile 4, as indicated in FIGS. 2 through 4.

As can be seen particularly from the sequence of the representations in FIGS. 2 through 4, the cable 10 is not deformed in the area of the hollow element during the process of closing the wing 2, so that the pivoting process of the wing is not hindered and the risk of pinching or squeezing the cable between the frame and the wing is avoided. The cable 10 is subject only to torsion within the hollow bolts 6, 7.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A device for guiding a cable between a fixed frame and a wing pivotably mounted to the frame via a hinge arrangement, wherein the hinge arrangement comprises a hinge bracket mounted for pivoting about a frame hinge axis within the frame and about a wing axis within the wing that extends parallel to the frame axis, comprising:
a hollow element which extends between the frame and the wing and is mounted to pivot about the frame axis and to pivot about the wing axis.

2. The device as claimed in claim 1, wherein the hollow element has a shape approximating a shape of the hinge bracket as viewed along at least one of the frame axis and the wing axis.

3. The device as claimed in claim 1, wherein the hollow element is an injection molded plastic part.

4. The device as claimed in claim 1, further comprising hollow bolts mounting the hollow element for pivoting respectively about the frame axis and about the wing axis, wherein the hollow bolts are configured to be received in respective bolt seats provided in the frame and in the wing.

5. An arrangement, comprising:
a frame;
a wing pivotably hinged to the frame; and
an element extending between the frame and the wing, wherein:
the element has a frame pivoting end and a wing pivoting end, and the element has an interior passage extending between the frame pivoting end and the wing pivoting end, and is configured to receive a cable extending into the frame at the frame pivoting end and into the wing at the wing pivoting end.

6. The arrangement according to claim 5, further comprising
a frame bolt pivotably mounting the frame pivoting end to the frame and provided with an interior passage configured to receive the cable extending into the frame; and
a wing bolt extending at least approximately parallel to the frame bolt and pivotably mounting the wing pivoting end to the wing and provided with an interior passage configured to receive the cable extending into the wing.
